(19) United States
(12) Patent Application Publication
(10) Pub. No.: US 2019/0087885 A1
(43) Pub. Date: Mar. 21, 2019

(54) DIAPER ORDERING SYSTEM AND METHOD

(71) Applicant: Cvilux Corporation, New Taipei City (TW)

(72) Inventors: Ming-Hui WEN, Taichung City (TW); Wei-Nan LIU, Taipei City (TW); Sean Jeremy Wilson, Columbia, MD (US)

(21) Appl. No.: 15/821,430

(22) Filed: Nov. 22, 2017

(30) Foreign Application Priority Data
Sep. 18, 2017 (TW) 106131967

(51) Int. Cl. G06Q 30/06; G06Q 10/08; G01K 13/00; G01N 27/12; G01N 27/22

(52) U.S. Cl. CPC G06Q 30/0633; G06Q 10/087; H04W 84/18; G01N 27/121; G01N 27/225; G01K 13/00

(57) ABSTRACT

The present disclosure provides diaper ordering system and method. In this method, a mobile device executes a mobile app to receive a user setting including a preset diaper quantity; a diaper sensor senses a usage parameter of a diaper, and the mobile device determines whether the diaper is needed to be replaced; if so, the mobile device is based on the preset diaper quantity to calculate a remaining diaper quantity. When the remaining diaper quantity is less than a threshold amount, the mobile app performs a diaper ordering process.

### RELATED APPLICATIONS

This application claims priority to Taiwan Patent Application No. 106131967, filed Sep. 18, 2017, the entirety of which is herein incorporated by reference.

### BACKGROUND

### Field of Invention

The present invention relates to voltage switching devices and voltage switching methods.

### Description of Related Art

A diaper or a nappy is a type of underwear that allows the wearer to defecate or urinate without the use of a toilet, by absorbing or containing waste products to prevent soiling of outer clothing or the external environment. Failure to change a diaper on a sufficiently regular basis can result in skin problems around the area covered by the nappy.

However, dependents (e.g., parents of infants) are often unsure when the diaper will run out and even forget to buy a new diaper.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to diaper ordering systems and methods.

An embodiment of the present disclosure is related to a diaper ordering system including a mobile device and a diaper sensor. The mobile device is configured to execute a mobile app to receive a user setting, and the user setting comprising a preset diaper quantity. The diaper sensor is configured to sense a usage parameter of a diaper and to transmit the usage parameter to the mobile device, so that the mobile device determines whether the diaper is needed to be replaced, the mobile device based on the preset diaper quantity to calculate a remaining diaper quantity whenever determining that the diaper is needed to be replaced, the mobile app performing a diaper ordering process when the remaining diaper quantity is less than a threshold amount.

In one embodiment, the diaper sensor includes a wireless transmission device, a temperature sensor, a humidity sensor and a controller. The temperature sensor is configured to sense a temperature value of the diaper. The humidity sensor is configured to sense the humidity value of the diaper. The controller is configured to incorporate the temperature value and the humidity value of the diaper into the usage parameter and to send the usage parameter the mobile device through the wireless transmission device, so that the mobile device is based on changes of the temperature value and the humidity value of the diaper over time to determine whether the diaper is needed to be replaced.

In one embodiment, the diaper ordering system further includes a cloud server. The cloud server is configured to store a table of comparison between diaper sizes and ages or weights, where the mobile device communicates with the cloud server, the user setting further includes a child age or a child weight, and the mobile app analyzes growth of the child age or the child weight over time and automatically adjusts a diaper size in the diaper ordering process according to the table.

In one embodiment, the mobile app analyzes a frequency of determination that the diaper is needed to be replaced, so as to adjust the threshold amount.

In one embodiment, after the mobile app prompts that the diaper is needed to be replaced, when the mobile device receives an input of changed information, but the usage parameter of the diaper sensor still reflects that the diaper is needed to be replaced, the mobile device determines that the remaining diaper quantity is not decreased.

Another embodiment of the present disclosure is related to a diaper ordering method including steps of: (A) using a mobile device to execute a mobile app to receive a user setting, and the user setting comprising a preset diaper quantity; and (B) using a diaper sensor to sense a usage parameter of a diaper and to transmit the usage parameter to the mobile device, so that the mobile device determines whether the diaper is needed to be replaced, the mobile device based on the preset diaper quantity to calculate a remaining diaper quantity whenever determining that the diaper is needed to be replaced, the mobile app performing a diaper ordering process when the remaining diaper quantity is less than a threshold amount.

In one embodiment, step (B) includes: using the diaper sensor to incorporate a temperature value and a humidity value of the diaper into the usage parameter and to send the usage parameter the mobile device, so that the mobile device is based on changes of the temperature value and the humidity value of the diaper over time to determine whether the diaper is needed to be replaced.

In one embodiment, the diaper ordering method further includes: using a cloud server to store a table of comparison between diaper sizes and ages or weights, wherein the mobile device communicates with the cloud server, the user setting further comprises a child age or a child weight, and the mobile app analyzes growth of the child age or the child weight over time and automatically adjusts a diaper size in the diaper ordering process according to the table.

In one embodiment, the diaper ordering method further includes: using the mobile app to analyze a frequency of determination that the diaper is needed to be replaced, so as to adjust the threshold amount.

In one embodiment, step (B) includes: after the mobile app prompts that the diaper is needed to be replaced, when the mobile device receives an input of changed information, but the usage parameter of the diaper sensor still reflects that the diaper is needed to be replaced, determining that the remaining diaper quantity is not decreased.

Technical advantages are generally achieved, by embodiments of the present invention. The present invention realizes the function of “automatic senses for purchase” and therefore greatly reduces the burden on the dependents.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a diaper ordering system according to some embodiments of the present disclosure; and

FIG. 2 is a flow chart of a diaper ordering method according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

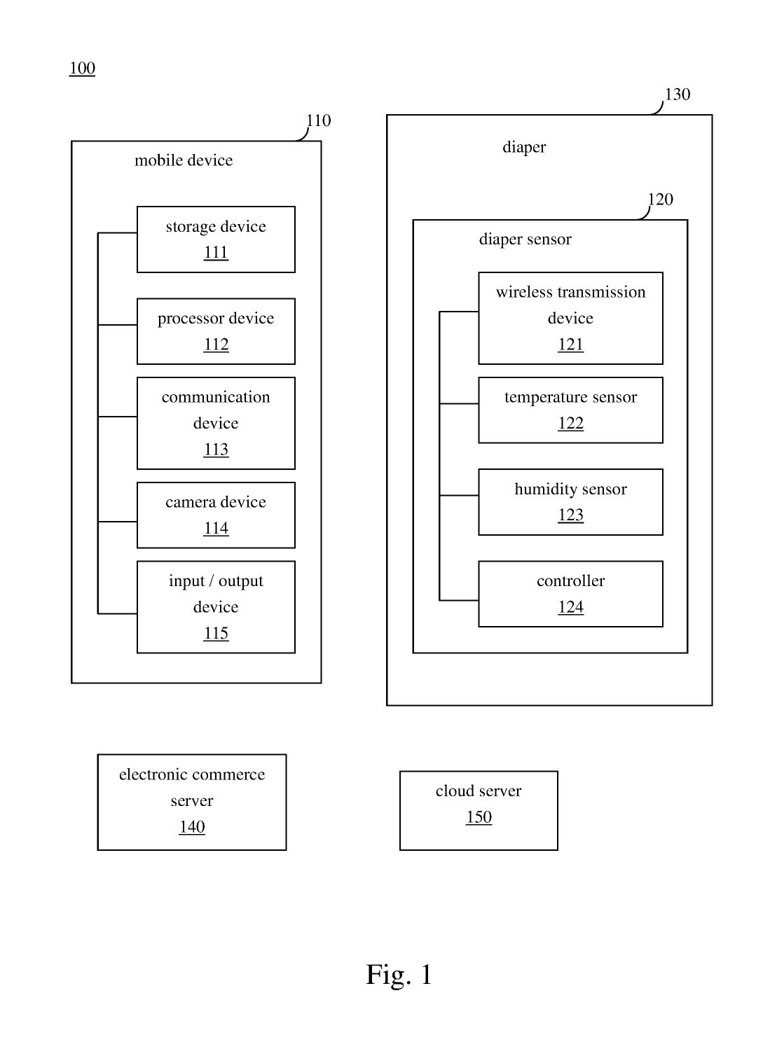

FIG. 1 is a block diagram of a diaper ordering system 100 according to some embodiments of the present disclosure. As shown in FIG. 1, the diaper ordering system 100 includes a mobile device 110 and a diaper sensor 120. The mobile device 110 can performs a diaper ordering process through an electronic commerce server 140. The mobile device 110 can wirelessly communicate with the diaper sensor 120. The diaper sensor 120 is detachably attached to the diaper 130 by means of a devil felt, a fastener, an adhesive, or the like, but the present invention is not limited thereto.

In FIG. 1, the mobile device 110 includes a storage device 111, a processor device 112, a communication device 113, a camera device 114 and an input/output device 115. In structure, the processor device 112 is electrically connected to the storage device 111, the communication device 113, the camera device 114 and the input/output device 115.

In practice, the mobile device 110 can be a mobile phone, a tablet, or a similar electronic device. The storage device 111 can be a hard disk or flash memory. The processor device 112 can be a central processor or a micro controller. The communication device 113 can include a Bluetooth module, a mobile network module, a regional wireless network module, and so on. The camera device 114 can be a camera module. The input/output device 115 can be a touch screen, a display with buttons, or a voice input device. For example, the chat-bot provides a message in text/picture, and a voice robot provides a voice message.

In use, the storage device 111 stores a mobile app, and the processor device 112 executes the mobile app. The communication device 113 communicates with the diaper sensor 120. The camera device 114 is used to take a photo. The user (e.g., parents of infants and young children) can operates the mobile app through the input/output device 115.

In some embodiments, the mobile device 110 executes the mobile app (e.g., diaper APP) to receive a user setting including the preset diaper quantity. For example, the user (e.g., parents of an infant or a young child) can use the input/output device 115 to manually enter a diaper brand, a diaper style, the purchased diaper quantity, and so on. Alternatively, the mobile app can automatically incorporate the purchased diaper quantity into the user setting through the electronic commerce server 140. Alternatively, the user can use the camera device 114 to scan the bar code on the diaper package so as to get the diaper brand, the diaper style, the diaper quantity of the diaper package, and so on from Internet through the communication device 113. As to the electronic commerce server 140, its API provides the diaper product information, and therefore there is no need to direct connect to an online shopping page of the electronic commerce server 140. In other embodiments, the mobile device 110 can access the online shopping page of the electronic commerce server 140. Those with ordinary skill in the art may flexibly design electronic commerce models depending on the desired application.

The diaper sensor 120 is configured to sense a usage parameter of the diaper and to transmit the usage parameter to the mobile device 110, so that the mobile device 110 determines whether the diaper is needed to be replaced. Whenever determining that the diaper is needed to be replaced, the mobile device 110 is based on the preset diaper quantity to calculate a remaining diaper quantity. When the remaining diaper quantity is less than a threshold amount, the mobile app performs the diaper ordering process. In this way, the diaper ordering system 100 implements the function of “automatic senses for purchase”, greatly reducing the burden on dependents.

For example, when the remaining diaper quantity is less than the threshold amount, the mobile device 110 automatically performs the diaper ordering process through the electronic commerce server 140 according to the user pre-set the shopping information. The mobile app provides the mechanism of buying feedback, so that the user can get the purchase receipt message.

In one embodiment, the mobile app analyzes a frequency of determination that the diaper 130 is needed to be replaced, so as to adjust the threshold amount. For example, the frequency of determination that the diaper 130 is needed to be replaced is high, and the threshold amount is increased; similarly, the frequency of determination that the diaper 130 is needed to be replaced is low, and the threshold amount is decreased. Thus, the diaper ordering system 100 intelligently adjust the reminder of the time according to the replacement frequency as to the diaper 130.

In addition to the function of the “automatic senses for purchase” described above, in an embodiment of the present invention, the user may also selectively execute the “schedule purchase” by the mobile app, whereby the mobile device 110 is scheduled to perform the diaper ordering process through the electronic commerce server 140.

In view of the above, there are three kinds of purchases: (1) the mobile app provides a message to notify the user of manual purchase; (2) the diaper sensor 120 measures the diaper inventory for triggering automatic purchase; (3) the mobile app periodically purchases diapers.

In one embodiment, the diaper ordering system 100 further includes a cloud server 150. The cloud server 150 is configured to store a table of comparison between diaper sizes and ages or weights, where the mobile device 110 communicates with the cloud server 150, the user setting further includes a child age or a child weight, and the mobile app analyzes growth of the child age or the child weight over time and automatically adjusts a diaper size in the diaper ordering process according to the table. Furthermore, the mobile app can also promote the purchase of different products (such as toys, etc.) in response to the child age.

In FIG. 1, the diaper sensor 120 includes a wireless transmission device 121, a temperature sensor 122, a humidity sensor 123 and a controller 124. In structure, the controller 124 is electrically connected to the wireless transmission device 121, the temperature sensor 122 and the humidity sensor 123.

In practice, the wireless transmission device 121 may be connected to a Bluetooth module or other short distance transmission module. The temperature sensor 122 may be an electronic component for converting the temperature into electronic data. The humidity sensor 123 may be a resistive and capacitive hygrometer. The controller 124 can be a micro-controller or other circuit.

In use, the temperature sensor 122 is configured to sense a temperature value of the diaper, and the humidity sensor 123 is configured to sense the humidity value of the diaper. The controller 124 is configured to incorporate the temperature value and the humidity value of the diaper 130 into the usage parameter and to send the usage parameter the mobile device 110 through the wireless transmission device 121, so that the mobile device 110 is based on changes of the temperature value and the humidity value of the diaper 130 over time to approximately forecast the amount of urine and/or the viscosity, the hardness and the amount of excretion, thereby determining whether the diaper is needed to be replaced.

In one embodiment, the mobile app prompts that the diaper is needed to be replaced. For example, the mobile device 110 displays a prompt message, a vibration reminder, a ring alert, etc. The user (e.g., parents) can replace the diaper 130 for his or her infant and/or young children. Then, the user enters changed information to the mobile device 110, and the mobile app records and deducts one from the remaining diaper quantity.

However, after the mobile app prompts that the diaper is needed to be replaced, when the mobile device 110 receives an input of changed information, but the usage parameter of the diaper sensor 120 still reflects that the diaper is needed to be replaced, it indicates that the user may be mistaken for input, so that the mobile device determines that the remaining diaper quantity is not decreased. Moreover, the mobile app still prompts that the diaper is needed to be replaced. In this way, the present invention can establish a fool-proofing mechanism to avoid the error estimation of the number of diapers.

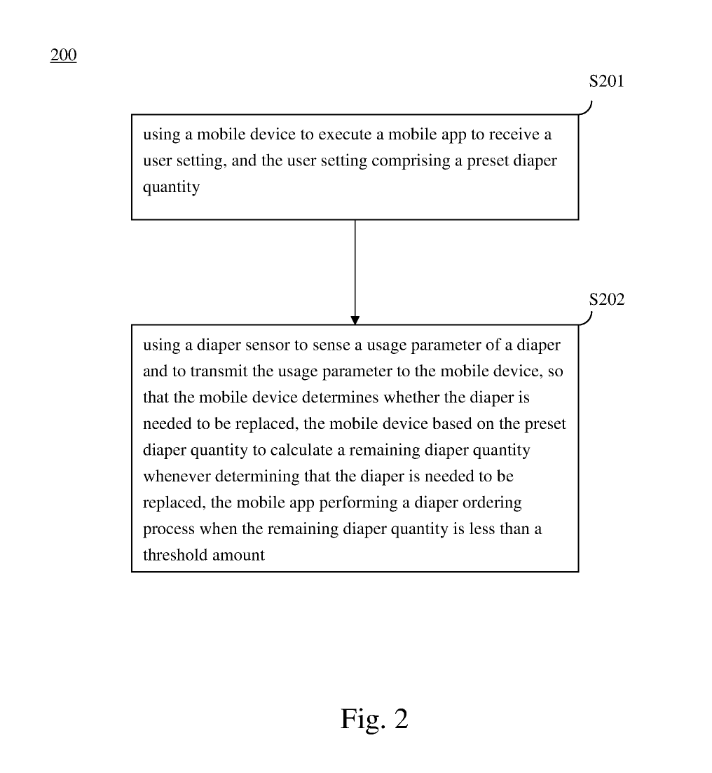

For a more complete understanding of a diaper ordering method performed by the diaper ordering system 100, referring FIGS. 1-2, FIG. 2 is a flow chart of the diaper ordering method 200 according to an embodiment of the present invention. As shown in FIG. 2, the diaper ordering method 200 includes operations S201 and S202. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In operation S201, the mobile device 110 is used to execute a mobile app to receive a user setting, and the user setting comprising a preset diaper quantity. In one embodiment, the mobile app can provide a chat-bot, a voice robot and so on.

In operation S202, the diaper sensor 120 is used to sense a usage parameter of the diaper 130 and to transmit the usage parameter to the mobile device 110, so that the mobile device 110 determines whether the diaper 130 is needed to be replaced, the mobile device 110 is based on the preset diaper quantity to calculate a remaining diaper quantity whenever determining that the diaper is needed to be replaced. When the remaining diaper quantity is less than a threshold amount, the mobile app performs a diaper ordering process, such as an order reminder or automatic order for diapers. Then, the mobile app provides the mechanism of buying feedback, so that the user can get the purchase receipt message.

In one embodiment, operation S202 includes: using the diaper sensor 120 to incorporate a temperature value and a humidity value of the diaper 130 into the usage parameter and to send the usage parameter the mobile device 110, so that the mobile device 110 is based on changes of the temperature value and the humidity value of the diaper over time to approximately forecast the amount of urine and/or the viscosity, the hardness and the amount of excretion, so as to determine whether the diaper 130 is needed to be replaced.

In the diaper ordering method 200, the cloud server 150 is used to store a table of comparison between diaper sizes and ages or weights, where the mobile device 110 communicates with the cloud server 150, the user setting further comprises a child age or a child weight, and the mobile app analyzes growth of the child age or the child weight over time and automatically adjusts a diaper size in the diaper ordering process according to the table. Furthermore, the mobile app can also promote the purchase of different products in response to the child age.

In the diaper ordering method 200, the mobile app is used to analyze a frequency of determination that the diaper is needed to be replaced, so as to adjust the threshold amount. Thus, the diaper ordering method 200 intelligently adjust the reminder of the time according to the replacement frequency as to the diaper 130.

In one embodiment, operation S202 includes: after the mobile app prompts that the diaper 130 is needed to be replaced, when the mobile device 110 receives an input of changed information, but the usage parameter of the diaper sensor still reflects that the diaper 130 is needed to be replaced, it indicates that the user may be mistaken for input, thereby determining that the remaining diaper quantity is not decreased and still prompting that the diaper is needed to be replaced. In this way, the present invention can establish a fool-proofing mechanism to avoid the error estimation of the number of diapers.

In view of above, the present invention realizes the function of “automatic senses for purchase” and therefore greatly reduces the burden on the dependents.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A diaper ordering system, comprising:
a mobile device configured to execute a mobile app to receive a user setting, and the user setting comprising a preset diaper quantity; and
a diaper sensor configured to sense a usage parameter of a diaper and to transmit the usage parameter to the mobile device, so that the mobile device determines whether the diaper is needed to be replaced, the mobile device based on the preset diaper quantity to calculate a remaining diaper quantity whenever determining that the diaper is needed to be replaced, the mobile app performing a diaper ordering process when the remaining diaper quantity is less than a threshold amount.

2. The diaper ordering system of claim 1, wherein the diaper sensor comprises:
a wireless transmission device;
a temperature sensor configured to sense a temperature value of the diaper;
a humidity sensor configured to sense the humidity value of the diaper; and
a controller configured to incorporate the temperature value and the humidity value of the diaper into the usage parameter and to send the usage parameter the mobile device through the wireless transmission device, so that the mobile device is based on changes of the temperature value and the humidity value of the diaper over time to determine whether the diaper is needed to be replaced.

3. The diaper ordering system of claim 1, further comprising:
a cloud server configured to store a table of comparison between diaper sizes and ages or weights, wherein the mobile device communicates with the cloud server, the user setting further comprises a child age or a child weight, and the mobile app analyzes growth of the child age or the child weight over time and automatically adjusts a diaper size in the diaper ordering process according to the table.

4. The diaper ordering system of claim 1, wherein the mobile app analyzes a frequency of determination that the diaper is needed to be replaced, so as to adjust the threshold amount.

5. The diaper ordering system of claim 1, wherein after the mobile app prompts that the diaper is needed to be replaced, when the mobile device receives an input of changed information, but the usage parameter of the diaper sensor still reflects that the diaper is needed to be replaced, the mobile device determines that the remaining diaper quantity is not decreased.

6. A diaper ordering method, comprising steps of:
(A) using a mobile device to execute a mobile app to receive a user setting, and the user setting comprising a preset diaper quantity; and
(B) using a diaper sensor to sense a usage parameter of a diaper and to transmit the usage parameter to the mobile device, so that the mobile device determines whether the diaper is needed to be replaced, the mobile device based on the preset diaper quantity to calculate a remaining diaper quantity whenever determining that the diaper is needed to be replaced, the mobile app performing a diaper ordering process when the remaining diaper quantity is less than a threshold amount.

7. The diaper ordering method of claim 6, wherein step (B) comprises:
using the diaper sensor to incorporate a temperature value and a humidity value of the diaper into the usage parameter and to send the usage parameter the mobile device, so that the mobile device is based on changes of the temperature value and the humidity value of the diaper over time to determine whether the diaper is needed to be replaced.

8. The diaper ordering method of claim 6, further comprising:
using a cloud server to store a table of comparison between diaper sizes and ages or weights, wherein the mobile device communicates with the cloud server, the user setting further comprises a child age or a child weight, and the mobile app analyzes growth of the child age or the child weight over time and automatically adjusts a diaper size in the diaper ordering process according to the table.

9. The diaper ordering method of claim 6, further comprising:
using the mobile app to analyze a frequency of determination that the diaper is needed to be replaced, so as to adjust the threshold amount.

10. The diaper ordering method of claim 6, wherein step (B) comprises:
after the mobile app prompts that the diaper is needed to be replaced, when the mobile device receives an input of changed information, but the usage parameter of the diaper sensor still reflects that the diaper is needed to be replaced, determining that the remaining diaper quantity is not decreased.
